(19) United States
(12) Patent Application Publication
(10) Pub. No.: US 2016/0113038 A1
(43) Pub. Date: Apr. 21, 2016

(54) USER TERMINAL, BASE STATION, AND PROCESSOR

(71) Applicant: KYOCERA CORPORATION, Kyoto (JP)

(72) Inventor: Tarou OTANI, Shinagawa-ku, Tokyo (JP)

(73) Assignee: KYOCERA CORPORATION, Kyoto (JP)

(21) Appl. No.: 14/896,807

(22) PCT Filed: Jun. 10, 2014
(86) PCT No.: PCT/JP2014/065325

§ 371 Date: Dec. 8, 2015

(30) Foreign Application Priority Data
Jun. 10, 2013 (JP) 2013-121774

(51) Int. Cl. H04W 74/08; H04W 52/38; H04W 4/22

(52) U.S. Cl. CPC H04W 74/0833; H04W 4/22; H04W 52/38

(57) ABSTRACT

UE 100-1 is used in a mobile communication system in which a voice call of a packet switching scheme is supported. The UE 100-1 transmits, to eNB 200, a random access signal to perform random access to the eNB 200 based on broadcast information received from the eNB 200. The broadcast information includes an emergency call parameter to be applied to transmission of an emergency call random access signal. When the random access is performed to originate an emergency call, the controller transmits the emergency call random access signal to the eNB 200 by applying the emergency call parameter included in the broadcast information.

### TECHNICAL FIELD

The present invention relates to a user terminal, a base station, and a processor in a mobile communication system that supports a voice call of a packet switching scheme.

### BACKGROUND ART

In 3rd generation partnership project (3GPP) that is a standardization project of a mobile communication system, standardization of voice over long term evolution (VoLTE) is ongoing. VoLTE is a technique of performing a voice call on a LTE system employing a packet switching scheme.

In VoLTE, a priority control mechanism is introduced to a radio resource control (RRC) layer and an upper layer higher than the RRC layer. The priority control refers to control of processing an emergency call with a higher priority than a normal call.

In the priority control in the RRC layer, a user terminal (a caller terminal) that originates an emergency call includes information indicating an emergency call in an RRC connection request message for requesting establishment of an RRC connection with a base station (see Non Patent Literature 1). The caller terminal transmits the RRC connection request message to the base station. The base station that has received the RRC connection request message preferentially performs a process for the caller terminal.

In the priority control in the upper layer, after the RRC connection with the base station is established, the caller terminal includes information indicating an emergency call in a session initiation protocol (SIP) message for establishing a session with a receiver terminal (see Non Patent Literature 2). The caller terminal transmits the SIP message to an IP multimedia subsystem (IMS). The IMS that has received the SIP message preferentially performs a process for the caller terminal.

### CITATION LIST

### Non Patent Literatures

Non Patent Literature 1: 3GPP technical specification “TS36.331 V11.3.0,” Mar. 18, 2013
Non Patent Literature 2: 3GPP technical specification “TS23.167 V11.6.0,” Dec. 18, 2012

### SUMMARY OF INVENTION

By the way, before the RRC connection with the base station is established, the user terminal performs random access to the base station in a media access control (MAC) layer lower than the RRC layer.

Here, for example, when a plurality of user terminals simultaneously perform random access to the base station, random access signals from a plurality of user terminals conflict with one another, and thus a random access failure may occur.

However, in current VoLTE, the priority control mechanism for processing an emergency call with a higher priority than a normal call has not been introduced to the MAC layer. For this reason, there is a problem in that despite an emergency call, a random access failure occurs, and it is difficult to quickly establish the RRC connection.

In this regard, it is an object of the present invention to provide a user terminal, a base station, and a processor, which are capable of controlling the occurrence of the random access failure in the emergency call.

A user terminal according to a first aspect is used in a mobile communication system in which a voice call of a packet switching scheme is supported. The user terminal includes a controller configured to transmit, to a base station, a random access signal to perform random access to the base station based on broadcast information received from the base station. The broadcast information includes an emergency call parameter to be applied to transmission of an emergency call random access signal. When the random access is performed to originate an emergency call, the controller transmits the emergency call random access signal to the base station by applying the emergency call parameter included in the broadcast information.

A base station according to a second aspect is used in a mobile communication system in which a voice call of a packet switching scheme is supported. The base station includes: a transmitter configured to transmit broadcast information including an emergency call parameter to be applied to transmission of an emergency call random access signal; and a receiver configured to receive the emergency call random access signal to which the emergency call parameter is applied, from a user terminal that performs random access to the base station to originate an emergency call.

A processor according to a third aspect is installed in a user terminal in a mobile communication system in which a voice call of a packet switching scheme is supported. The processor performs a process of transmitting, to a base station, a random access signal to perform random access to the base station based on broadcast information received from the base station. The broadcast information includes an emergency call parameter to be applied to transmission of an emergency call random access signal. When the random access is performed to originate an emergency call, the processor transmits the emergency call random access signal to the base station by applying the emergency call parameter included in the broadcast information.

### BRIEF DESCRIPTION OF DRAWINGS

FIG. 1 is a configuration diagram of an LTE system according to first and second embodiments.

FIG. 2 is a block diagram of a UE according to the first and second embodiments.

FIG. 3 is a block diagram of an eNB according to the first and second embodiments.

FIG. 4 is a protocol stack diagram of a wireless interface in an LTE system.

FIG. 5 is a configuration diagram of a radio frame used in an LTE system.

FIG. 6 is a diagram illustrating an operation environment according to the first and second embodiments.

FIG. 7 is a diagram illustrating a signal sequence of a random access signal according to the first embodiment.

FIG. 8 is an operation sequence diagram according to the first embodiment.

FIG. 9 is a diagram illustrating “PRACH-ConfigSIB” according to the first embodiment.

FIG. 10 is a diagram illustrating transmission power of a random access signal according to the second embodiment.

FIG. 11 is a diagram illustrating “RACH-ConfigCommon” according to the second embodiment.

FIG. 12 is an operation sequence diagram according to the second embodiment.

### DESCRIPTION OF EMBODIMENTS

### Overview of Embodiments

A user terminal according to first and second embodiments is used in a mobile communication system in which a voice call of a packet switching scheme is supported. The user terminal includes a controller configured to transmit, to a base station, a random access signal to perform random access to the base station based on broadcast information received from the base station. The broadcast information includes an emergency call parameter to be applied to transmission of an emergency call random access signal. When the random access is performed to originate an emergency call, the controller transmits the emergency call random access signal to the base station by applying the emergency call parameter included in the broadcast information.

In the first and second embodiments, the broadcast information further includes information whether or not the base station supports the emergency call random access signal. When the random access is performed to originate an emergency call, and the base station supports the emergency call random access signal, the controller transmits the emergency call random access signal to the base station by applying the emergency call parameter included in the broadcast information.

In the first embodiment, the emergency call parameter is a parameter indicating an emergency call signal sequence that is a signal sequence to be applied to the transmission of the emergency call random access signal.

In the first embodiment, the emergency call signal sequence is secured separately from a signal sequence to be applied to transmission of a non-emergency call random access signal.

In the second embodiment, the emergency call parameter is a parameter indicating emergency call transmission power that is transmission power to be applied to the transmission of the emergency call random access signal.

In the second embodiment, the emergency call transmission power is set to power higher than transmission power to be applied to transmission of a non-emergency call random access signal.

A base station according to first and second embodiments is used in a mobile communication system in which a voice call of a packet switching scheme is supported. The base station includes: a transmitter configured to transmit broadcast information including an emergency call parameter to be applied to transmission of an emergency call random access signal; and a receiver configured to receive the emergency call random access signal to which the emergency call parameter is applied, from a user terminal that performs random access to the base station to originate an emergency call.

In the first and second embodiments, the broadcast information further includes information indicating whether or not the base station supports the emergency call random access signal.

In the first embodiment, the base station further includes a controller configured to preferentially perform a process for the emergency call random access signal when reception of the emergency call random access signal conflicts with reception of a non-emergency call random access signal.

In the first embodiment, the emergency call parameter is a parameter indicating an emergency call signal sequence that is a signal sequence to be applied to transmission of the emergency call random access signal.

In the first embodiment, the emergency call signal sequence is secured separately from a signal sequence to be applied to transmission of the non-emergency call random access signal.

In the second embodiment, the emergency call parameter is a parameter indicating emergency call transmission power that is transmission power to be applied to transmission of the emergency call random access signal.

In the second embodiment, the emergency call transmission power is set to power higher than transmission power to be applied to transmission of a non-emergency call random access signal.

A processor according to first and second embodiments is installed in a user terminal in a mobile communication system in which a voice call of a packet switching scheme is supported. The processor performs a process of transmitting, to a base station, a random access signal to perform random access to the base station based on broadcast information received from the base station. The broadcast information includes an emergency call parameter to be applied to transmission of an emergency call random access signal. When the random access is performed to originate an emergency call, the processor transmits the emergency call random access signal to the base station by applying the emergency call parameter included in the broadcast information.

### First Embodiment

Hereinafter, a first embodiment in which the present invention is applied to an LTE system will be described.

(System Configuration)

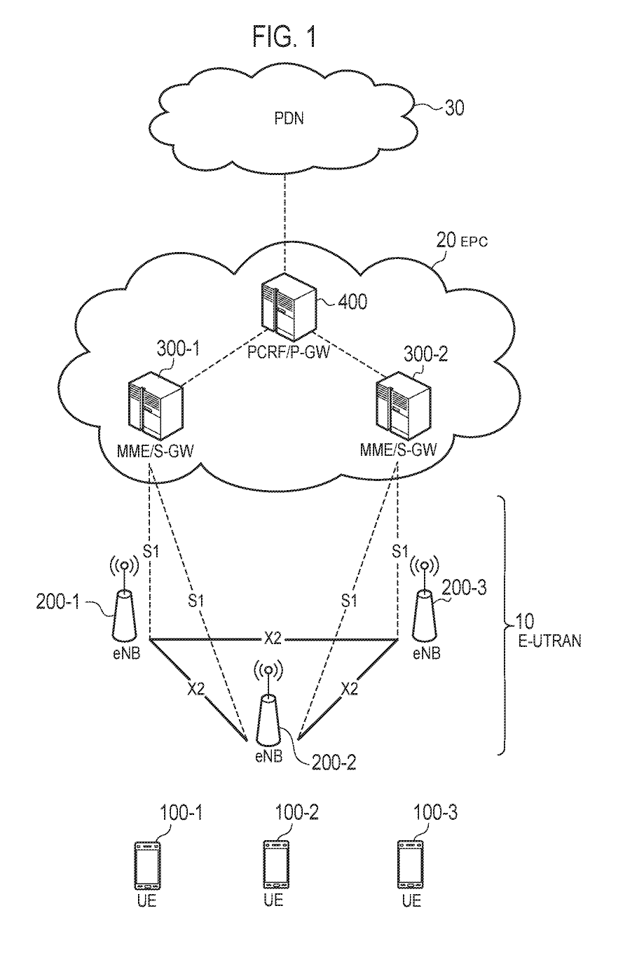

FIG. 1 is a configuration diagram of an LTE system according to the first embodiment. The LTE system according to the first embodiment supports a voice call (VoLTE) of a packet switching scheme.

The LTE system according to the first embodiment includes user equipment (UE) 100, an evolved-UMTS terrestrial radio access network (E-UTRAN) 10, an evolved packet core (EPC) 20, and a packet data network (PDN) 30 as illustrated in FIG. 1.

The UE 100 corresponds to a user terminal. The UE 100 is a mobile communication device, and performs wireless communication with a cell (a serving cell) of a connection destination. A configuration of the UE 100 will be described later.

The E-UTRAN 10 corresponds to a wireless access network. The E-UTRAN 10 includes an evolved Node-B (eNB) 200. The eNB 200 corresponds to a base station. The eNBs 200 are connected with one another via an X2 interface. A configuration of the eNB 200 will be described later.

The eNB 200 manages one or more cells. The eNB 200 performs wireless communication with the UE 100 that has established a connection its own cell. The eNB 200 has a radio resource management (RRM) function, a user data routing function, a measurement control function for mobility control/scheduling, and the like. A “cell” is used as a term indicating a minimum unit of a wireless communication area. The “cell” is also used as a term indicating a function of performing wireless communication with the UE 100.

The EPC 20 corresponds to a core network. The EPC 20 includes a mobility management entity/serving-gateway (MME/S-GW) 300. The MME performs various kinds of mobility control on the UE 100. The S-GW performs user data transfer control. The MME/S-GW 300 is connected with the eNB 200 via an S1 interface. The EPC 20 further includes a policy and charging rules function/PDN gateway (PCRF/P-GW) 400. The PCRF performs QoS control, accounting control, and the like. The P-GW is a connection point with the PDN 30, and performs user data transfer control.

The PDN 30 corresponds to an IP multimedia subsystem (IMS) for an IP multimedia service. The PDN 30 provides a voice call service using an SIP and the like.

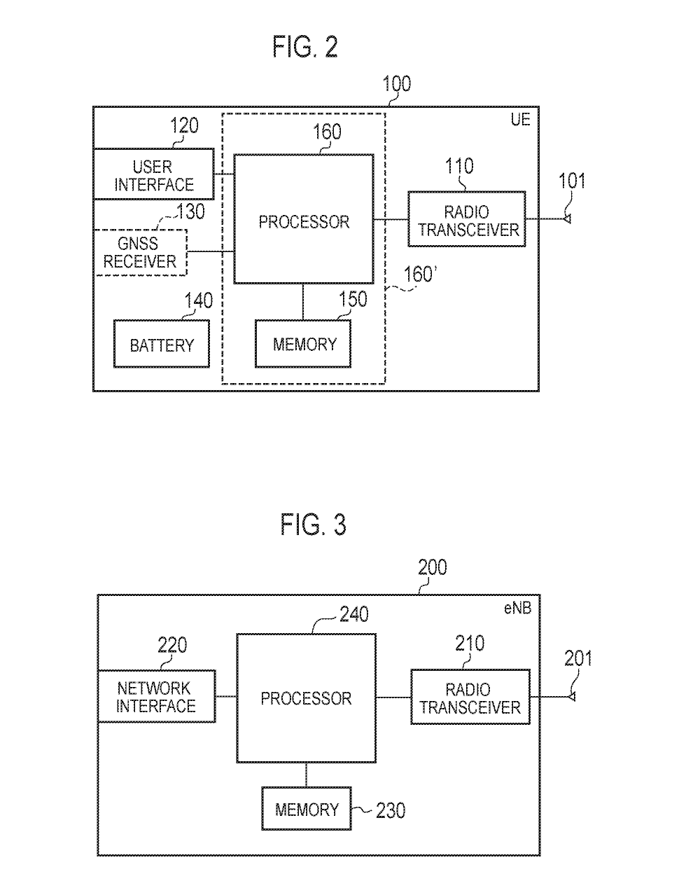

FIG. 2 is a block diagram of the UE 100. As illustrated in FIG. 2, the UE 100 includes an antenna 101, a radio transceiver 110, a user interface 120, a GNSS (Global Navigation Satellite System) receiver 130, a battery 140, a memory 150, and a processor 160. The memory 150 and the processor 160 constitute a controller. The UE 100 may not have the GNSS receiver 130. Furthermore, the memory 150 may be integrally formed with the processor 160, and this set (that is, a chip set) may be called a processor 160′.

The antenna 101 and the radio transceiver 110 are used to transmit and receive a radio signal. The radio transceiver 110 converts a baseband signal (a transmission signal) output from the processor 160 into the radio signal and transmits the radio signal from the antenna 101. Furthermore, the radio transceiver 110 converts a radio signal received by the antenna 101 into a baseband signal (a received signal), and outputs the baseband signal to the processor 160.

The user interface 120 is an interface with a user carrying the UE 100, and includes, for example, a display, a microphone, a speaker, various buttons and the like. The user interface 120 accepts an operation from a user and outputs a signal indicating the content of the operation to the processor 160. The GNSS receiver 130 receives a GNSS signal to obtain location information indicating a geographical location of the UE 100, and outputs the received signal to the processor 160. The battery 140 accumulates power to be supplied to each block of the UE 100.

The memory 150 stores a program to be executed by the processor 160 and information to be used for a process by the processor 160. The processor 160 includes a baseband processor that performs modulation and demodulation, encoding and decoding and the like on the baseband signal, and CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As illustrated in FIG. 3, the eNB 200 includes an antenna 201, a radio transceiver 210, a network interface 220, a memory 230, and a processor 240. The memory 230 and the processor 240 constitute a controller.

The antenna 201 and the radio transceiver 210 are used to transmit and receive a radio signal. The radio transceiver 210 converts a baseband signal (a transmission signal) output from the processor 240 into the radio signal and transmits the radio signal from the antenna 201. Furthermore, the radio transceiver 210 converts a radio signal received by the antenna 201 into a baseband signal (a received signal), and outputs the baseband signal to the processor 240.

The network interface 220 is connected to the neighboring eNB 200 via the X2 interface and is connected to the MME/S-GW 300 via the S1 interface. The network interface 220 is used in communication over the X2 interface and communication over the S1 interface.

The memory 230 stores a program to be executed by the processor 240 and information to be used for a process by the processor 240. The processor 240 includes a baseband processor that performs modulation and demodulation, encoding and decoding and the like on the baseband signal and CPU that performs various processes by executing the program stored in the memory 230. The processor 240 executes various processes and various communication protocols described later.

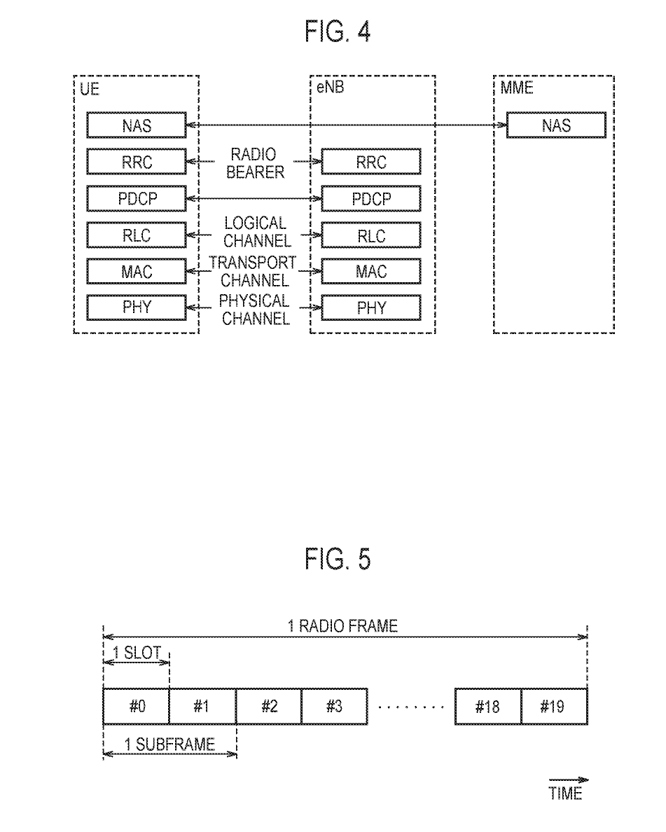

FIG. 4 is a protocol stack diagram of a radio interface in the LTE system. As illustrated in FIG. 4, the radio interface protocol is classified into a layer 1 to a layer 3 of an OSI reference model, wherein the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, data is transmitted via the physical channel.

The MAC layer performs priority control of data, a retransmission process by hybrid ARQ (HARQ), a random access procedure in establishing RRC connection, and the like. Between the MAC layer of the UE 100 and the MAC layer of the eNB 200, data is transmitted via a transport channel. The MAC layer of the eNB 200 includes a scheduler for determining transport format of an uplink and a downlink (a transport block size and a modulation and coding scheme) and resource blocks to be assigned to UE 100. The details of the random access procedure will be described later.

The RLC layer transmits data to an RLC layer of a reception side by using the functions of the MAC layer and the PHY layer. Between the RLC layer of the UE 100 and the RLC layer of the eNB 200, data is transmitted via a logical channel.

The PDCP layer performs header compression and decompression, and encryption and decryption.

The RRC layer is defined only in a control plane for dealing with control signals. Between the RRC layer of the UE 100 and the RRC layer of the eNB 200, control messages (RRC messages) for various types of configuration is transmitted. The RRC layer controls the logical channel, the transport channel, and the physical channel in response to establishment, re-establishment, and release of a radio bearer. When there is a connection (RRC connection) between the RRC of the UE 100 and the RRC of the eNB 200, the UE 100 is in an RRC connected state, otherwise the UE 100 is in an RRC idle state.

A NAS (Non-Access Stratum) layer positioned above the RRC layer performs a session management, a mobility management and the like.

FIG. 5 is a configuration diagram of a radio frame used in the LTE system. In the LTE system, OFDMA (Orthogonal Frequency Division Multiplexing Access) is applied to a downlink, and SC-FDMA (Single Carrier Frequency Division Multiple Access) is applied to an uplink, respectively.

As illustrated in FIG. 5, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. The resource block includes a plurality of subcarriers in the frequency direction. Among radio resources assigned to the UE 100, a frequency resource can be specified by a resource block and a time resource can be specified by a subframe (or slot).

In the downlink, an interval of several symbols at the head of each subframe is a control region used as a physical downlink control channel (PDCCH) for mainly transmitting a control signal. Furthermore, the other interval of each subframe is a region available as a physical downlink shared channel (PDSCH) for mainly transmitting user data.

In the uplink, both ends in the frequency direction of each subframe are control regions used as a physical uplink control channel (PUCCH) for mainly transmitting a control signal. The central six resource blocks in the frequency direction of each subframe is a region available as a physical random access channel (PRACH) for transmitting random access signals. Other portions in the frequency direction of each subframe is a region available as a physical uplink shared channel (PUSCH) for mainly transmitting user data.

(Random Access Procedure)

Before establishing the RRC connection with the eNB 200, the UE 100 performs random access to the eNB 200 in the MAC layer. Here, general random access in the LTE system is described.

Before the random access, the UE 100 establishes downlink synchronization with the cell of the eNB 200 through a cell search. One of purposes of the random access is establishing uplink synchronization with the cell.

As a first process of the random access procedure, the UE 100 transmits a random access signal to the eNB 200 through a physical random access channel (PRACH). The random access signal is a signal for performing random access from the UE 100 to the eNB 200 in the MAC layer. The random access signal is called a random access preamble in the specification.

As resources used for transmission of the random access signal, there are a signal sequence of the random access signal, a transmission timing of the random access signal, and the like. Hereinafter, the resources are referred to as “random access resources.”

When the UE 100 in an RRC idle state performs the random access, the UE 100 receives broadcast information from the eNB 200. The UE 100 selects the random access resources based on the received broadcast information. The broadcast information includes a master information block (MIB) and a system information block (SIB). The broadcast information is information that can be received and decoded by the UE 100 in the RRC idle state. A plurality of types are specified in the SIB. Of these, a type 2 (an SIB 2) of the SIB includes information necessary when the UE 100 accesses the cell of the eNB 200. For example, the SIB 2 includes information related to an uplink bandwidth, information related to the PRACH, and information related to uplink power control. The PRACH information included in the SIB 2 is referred to as a “PRACH-ConfigSIB.” The UE 100 transmits the random access signal to the eNB 200 using the random access resources selected based on the “PRACH-ConfigSIB.” Such random access is referred to as a “contention base.” In the contention base, as a plurality of UEs 100 transmit the random access signal to the eNB 200 using the same random access resources, contention occurs.

Meanwhile, when the UE 100 in an RRC connection state performs a handover, the random access resources are designated from a cell of a handover source to the UE 100. Then, the UE 100 transmits the random access signal to a cell of a handover destination using the designated random access resources. Such random access that is performed under control of the eNB 200 is referred to as a “non-contention base.”

As a second process of the random access procedure, the eNB 200 estimates an uplink delay with the UE 100 based on the random access signal received from the UE 100. Further, the eNB 200 decides radio resources to be allocated to the UE 100. Then, the eNB 200 transmits a random access response to the UE 100. The random access response includes a timing correction value based on a delay estimation result, information of the decided allocation radio resources, information indicating the signal sequence of the random access signal received from the UE 100, and the like.

In one of the following cases, there are cases in which it is difficult to complete the second process by the eNB 200, or a long time is necessary until the random access response is transmitted:
when congestion is occurring in the eNB 200;
when the eNB 200 concurrently receives the random access signal from a number of UEs 100; and
when it is difficult to detect the random access signal by the eNB 200.

After transmitting the random access signal, the UE 100 receives the random access response including information corresponding to the random access signal within a predetermined period of time. In this case, the UE 100 determines that the random access has been successfully performed. Otherwise, the UE 100 determines that the random access failure has occurred, and performs the first process again. In second transmission of the random access signal, in order to increase a success rate of the random access, the UE 100 sets transmission power to be higher than in the first transmission of the random access signal.

As a third process of the random access procedure, the UE 100 determined to have successfully performed the random access transmits an RRC connection request message to the eNB 200 based on information included in the random access response. The RRC connection request message is a message that is transmitted in the RRC layer and used to request establishment of the RRC connection. The RRC connection request message includes an identifier of the UE 100 of a transmission source.

As a fourth process of the random access procedure, the eNB 200 transmits a response message to the RRC connection request message to the UE 100. The response message includes an identifier of the UE 100 of a transmission destination. When the contention has occurred due to the use of the same random access resources, a plurality of UEs 100 may react to the same random access response. Such contention is solved by the fourth process.

(Operation According to First Embodiment)

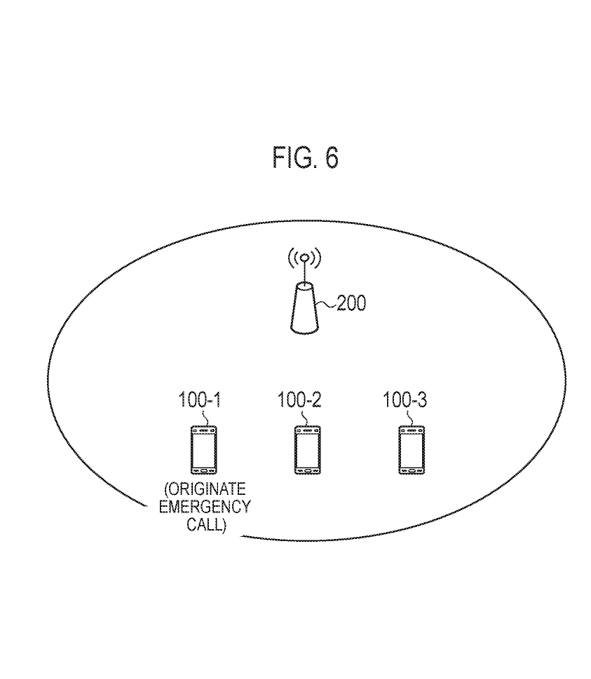

Next, an operation according to the first embodiment will be described. FIG. 6 is a diagram illustrating an operation environment according to the first embodiment.

As illustrated in FIG. 6, a plurality of UEs (UEs 100-1 to 100-3) in the RRC idle state are located within a coverage area of the eNB 200. Here, a situation in which a plurality of UEs 100 concurrently perform the random access of the contention base to the eNB 200 is assumed.

The UE 100-1 is a UE that originates an emergency call to a receiver terminal installed in an emergency call receiving organization such as a police station, a fire station, or a rescue agency. The UEs 100-2 and 100-3 are UEs that perform, for example, a voice call or data communication that is less urgent.

In this situation, it is undesirable that the random access failure occurs in the UE 100-1. It is because due to the random access failure, the establishment of the RRC connection is delayed, and a time taken until the voice call with the receiver terminal installed in the emergency call receiving organization is initiated is consequently increased. In this regard, in the first embodiment, the priority control mechanism for preferentially processing the emergency call is introduced to the MAC layer as follows.

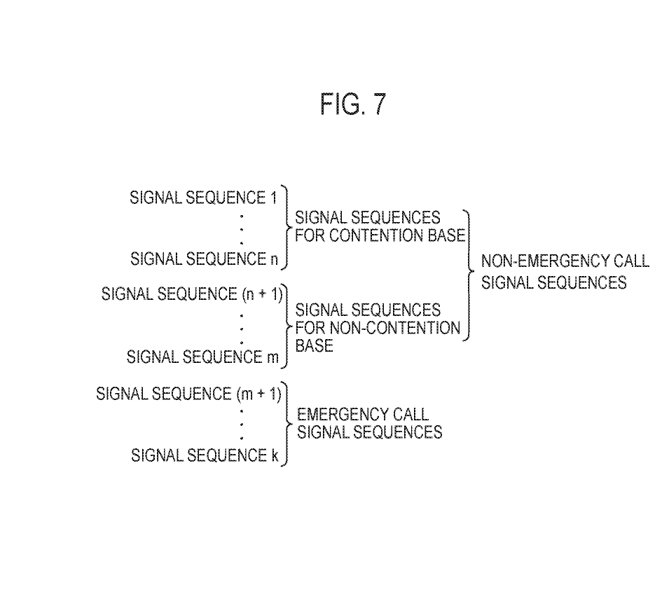

FIG. 7 is a diagram illustrating a signal sequence of a random access signal according to the first embodiment.

A maximum of 64 (that is, k=64) signal sequences of the random access signal are prepared for each cell as illustrated in FIG. 7. The eNB 200 secures some signal sequences among the 64 signal sequences as a signal sequence for an emergency call (emergency call signal sequence), and uses the remaining signal sequences for non-emergency calls. The non-emergency call signal sequences are classified into contention base signal sequences and non-contention base signal sequences. Hereinafter, a random access signal used for random access by an emergency call is referred to as “a random access signal for emergency call (an emergency call random access signal).” On the other hand, a random access signal used for random access by a call other than an emergency call is referred to as “a random access signal for non-emergency call (a non-emergency call random access signal.)”

As described above, the emergency call signal sequence is secured separately from a signal sequence to be applied to transmission of the non-emergency call random access signal.

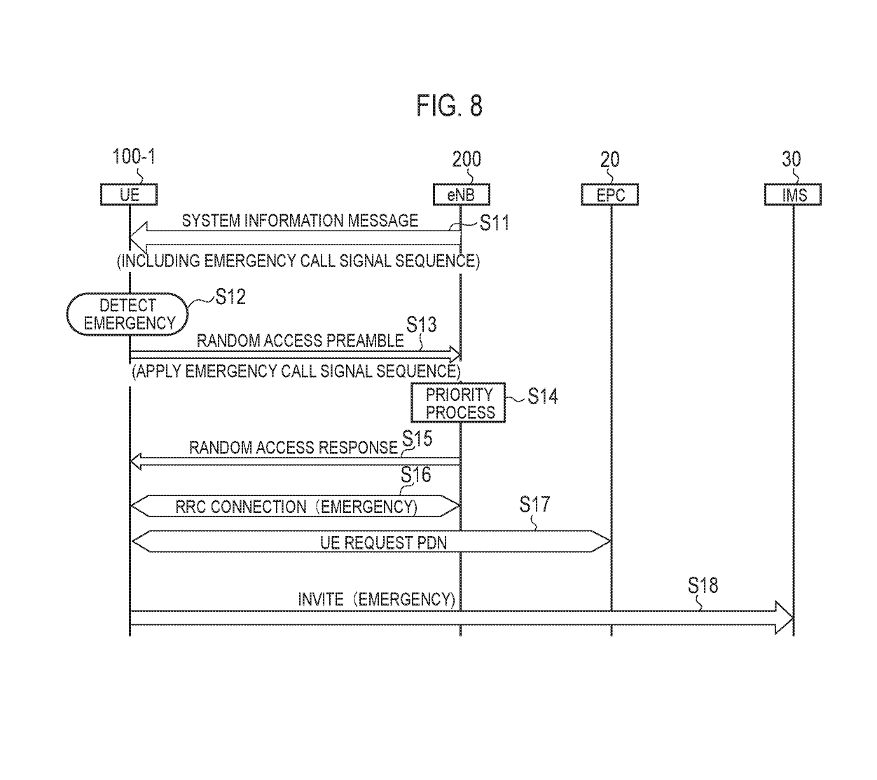

FIG. 8 is an operation sequence diagram according to the first embodiment. In an initial state of the present sequence, the UE 100-1 is in the RRC idle state.

As illustrated in FIG. 8, in step S11, the eNB 200 transmits the broadcast information (the SIB 2) including the “PRACH-ConfigSIB.” The UE 100-1 stores the “PRACH-ConfigSIB” received from the eNB 200. The “PRACH-ConfigSIB” includes information indicating whether or not the eNB 200 supports the emergency call random access signal. Further, in the first embodiment, when the eNB 200 supports the emergency call random access signal, the “PRACH-ConfigSIB” includes a parameter indicating the emergency call signal sequence (emergency call parameter). A configuration of the “PRACH-ConfigSIB” will be described later.

In step S12, the UE 100-1 detects an emergency call origination operation using the user interface 120. The UE 100-1 that has detected the emergency call origination operation starts the random access procedure to the eNB 200 in order to transition to the RRC connection state. The UE 100-1 determines that the eNB 200 supports the emergency call random access signal based on the “PRACH-ConfigSIB” received from the eNB 200 in step S11. Further, the UE 100-1 selects any one emergency call signal sequence among from the emergency call signal sequences included in the “PRACH-ConfigSIB.”

In step S13, the UE 100-1 applies the selected emergency call signal sequence, and transmits the emergency call random access signal to the eNB 200. The eNB 200 receives the emergency call random access signal from the UE 100-1.

In step S14, the eNB 200 recognizes that the signal sequence applied to the random access signal received from the UE 100-1 is the emergency call signal sequence, and determines that the random access is the random access by the emergency call. Further, when reception of the emergency call random access signal conflicts with reception of the non-emergency call random access signal, the eNB 200 preferentially processes the emergency call random access signal. For example, the eNB 200 transmits the random access response to the emergency call random access signal with the top priority.

In step S15, the eNB 200 transmits the random access response to the UE 100-1. The UE 100-1 receives the random access response from the eNB 200.

In step S16, the UE 100-1 and the eNB 200 perform the third and fourth processes for establishing the RRC connection. Here, the UE 100-1 includes the information indicating the emergency call in the RRC connection request message, and transmits the RRC connection request message including the information to the eNB 200. The eNB 200 that has received the RRC connection request message preferentially performs a process for the UE 100-1.

In step S17, the UE 100-1 and the EPC 20 perform, for example, a network registration process of the UE 100-1.

In step S18, the UE 100-1 transmits an INVITE message that is a sort of the SIP message to the PDN 30 (the IMS) in order to establish a session with the receiver terminal. Here, the UE 100-1 includes the information indicating the emergency call in the INVITE message, and transmits the INVITE message including the information to the PDN 30 (the IMS). The PDN 30 (the IMS) that has received the INVITE message preferentially performs a process for the UE 100-1.

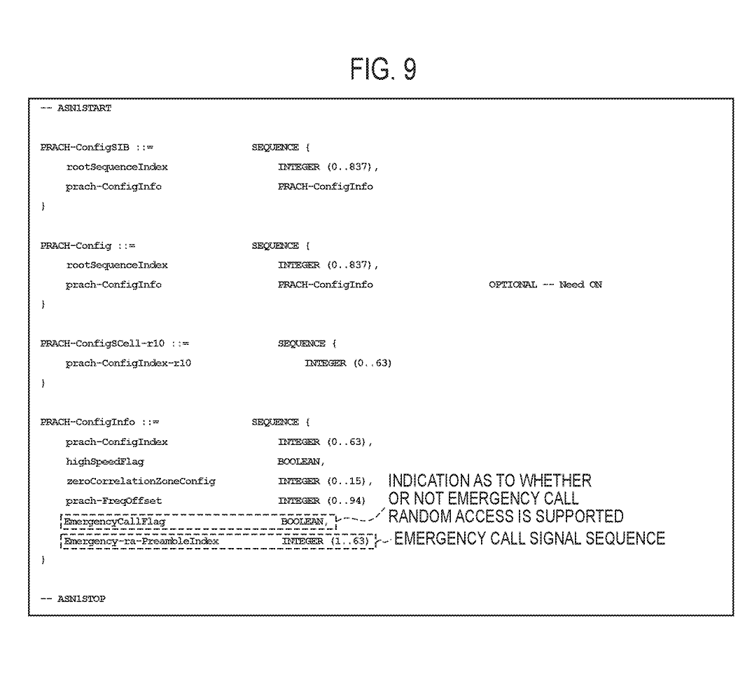

FIG. 9 is a diagram illustrating the “PRACH-ConfigSIB” according to the first embodiment.

As illustrated in FIG. 9, the “PRACH-ConfigSIB” includes “rootSequenceIndex” and “PRACH-ConfigInfo.” “rootSequenceIndex” is a parameter related to a root signal sequence of the random access signal. A Zadoff-Chu sequence is used as the root signal sequence. By cyclic-shifting the root signal sequence, it is possible to generate the random access signals of 64 sequences from one root signal sequence. “PRACH-ConfigInfo” is a parameter related to other PRACH settings.

“PRACH-ConfigInfo” includes “prach-ConfigIndex,” “highSpeedFlag,” “zeroCorrelationZoneConfig,” and “prach-FreqOffset.” “prach-ConfigIndex” is a parameter related to a format, a transmission radio frame, and a transmission subframe of the random access signal. “highSpeedFlag” is a parameter related to restriction of the number of available signal sequences. “zeroCorrelationZoneConfig” is a parameter related to the cyclic shift of the root signal sequence. “prach-FreqOffset” is a parameter related to a frequency offset of the random access signal.

In the first embodiment, “PRACH-ConfigInfo” includes “EmergencyCallFlag” and “Emergency-ra-PreambleIndex” as a new information element (IE).

“EmergencyCallFlag” is information indicating whether or not the cell of the eNB 200 supports the emergency call random access signal. “EmergencyCallFlag” is set to either of “TRUE” and “FALSE.” “TRUE” indicates that the emergency call random access signal is supported. “FALSE” indicates that the emergency call random access signal is not supported.

“Emergency-ra-PreambleIndex” is a parameter indicating the emergency call signal sequence. A value designated by “Emergency-ra-PreambleIndex” may be set not to be designated in a normal call random access preamble (the non-emergency call random access signal).

The UE 100-1 that originates the emergency call recognizes that the emergency call random access signal is supported when “EmergencyCallFlag” is “TRUE.” In this case, the UE 100-1 applies the signal sequence indicated by “Emergency-ra-PreambleIndex” to the random access signal.

On the other hand, the UEs 100-2 and 100-3 that do not originate the emergency call apply the signal sequence other than the signal sequence indicated by “Emergency-ra-PreambleIndex” to the random access signal when “EmergencyCallFlag” is “TRUE.”

(Conclusion of First Embodiment)

In the first embodiment, the broadcast information (the SIB 2) includes the emergency call signal sequence to be applied to transmission of the emergency call random access signal. The emergency call signal sequence is secured separately from the signal sequence to be applied to transmission of the non-emergency call random access signal.

The UE 100-1 applies the emergency call signal sequence included in the broadcast information, and transmits the emergency call random access signal to the eNB 200 when the random access is performed in order to originate the emergency call. The eNB 200 receives the emergency call random access signal to which the emergency call signal sequence is applied from the UE 100-1.

Thus, the eNB 200 can recognize that the random access is the random access by the emergency call and perform the priority control for preferentially processing the emergency call. Specifically, the eNB 200 preferentially processes the emergency call random access signal when reception of the emergency call random access signal conflicts with reception of the non-emergency call random access signal.

Thus, since the random access failure in the emergency call can be suppressed, the UE 100-1 can quickly establish the RRC connection in the emergency call and quickly start the voice call.

### Modified Example of First Embodiment

The first embodiment may be modified as follows.

A case in which the UE 100-1 designates a value of Emergency-ra-RreambleIndex, and transmits the random access preamble (the emergency call random access signal), and the designated value is already being used by another UE is assumed. In this case, the eNB 200 designates ra-PreambleIndex that is not allocated to other UEs, and transmits a random access preamble assignment to the UE 100-1. In other words, the eNB 200 allocates ra-PreambleIndex to the UE 100-1 through the non-contention base. Then, the UE 100-1 designates a value of ra-PreambleIndex designated in the random access preamble assignment, and transmits the random access preamble.

### Second Embodiment

A description will proceed with a difference between the second embodiment and the first embodiment. A system configuration and an operation environment of the second embodiment are the same as in the first embodiment. In the second embodiment, the occurrence of the random access failure in the emergency call is suppressed by controlling the transmission power of the random access signal.

(Random Access Signal Transmission Power)

Here, general random access signal transmission power in the LTE system will be described.

The UE 100 sets the transmission power of the random access signal based on the broadcast information (SIB) received from the eNB 200. The broadcast information includes “RadioResourceConfigCommonSIB” indicating a common radio resource setting in a cell.

“RadioResourceConfigCommonSIB” includes “RACH-ConfigCommon” related to the random access. “RACH-ConfigCommon” includes “preambleInitialReceivedTargetPower” and “powerRampingStep.” “preambleInitialReceivedTargetPower” is a parameter indicating initial transmission power of the random access signal. “powerRampingStep” is a parameter indicating an increase in the second or later transmission power of the random access signal.

The RRC layer of the UE 100 notifies the MAC layer of the UE 100 of “preambleInitialReceivedTargetPower” and “powerRampingStep.” The MAC layer of the UE 100 calculates “PREAMBLE_RECEIVED_TARGET_POWER” indicating the transmission power of the random access signal through the following Formula:

preambleInitialReceivedTargetPower+DELTA_PREAMBLE+(PREAMBLE_TRANSMISSION_COUNTER−1)*powerRampingStep

Here, “DELTA_PREAMBLE” is a parameter indicating an offset that is decided according to a format of the random access signal. “PREAMBLE_TRANSMISSION_COUNTER” is a parameter indicating the number of repetitive transmissions of the random access signal.

The MAC layer of the UE 100 notifies the physical layer of the UE 100 of the calculated “PREAMBLE_RECEIVED_TARGET_POWER.” The physical layer of the UE 100 transmits the random access signal to the eNB 200 at the transmission power according to “PREAMBLE_RECEIVED_TARGET_POWER” reported from the MAC layer.

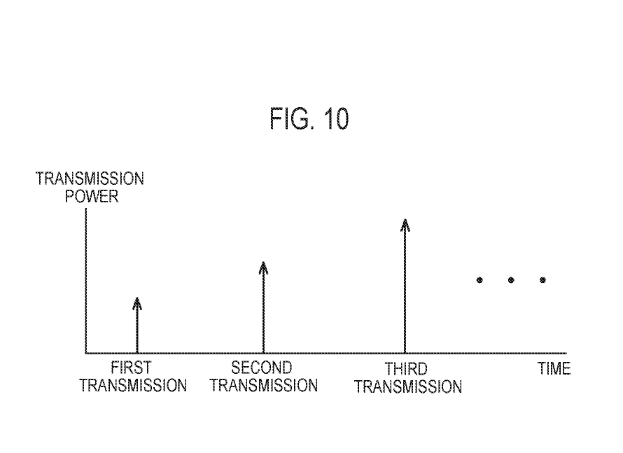

FIG. 10 is a diagram illustrating the transmission power of the random access signal.

As illustrated in FIG. 10, the UE 100 transmits a first random access signal. The UE 100 sets the transmission power decided by “preambleInitialReceivedTargetPower” as the transmission power of the first random access signal.

Then, the UE 100 transmits a second random access signal when the random access failure is determined to have occurred. In order to increase the success rate of the random access, in transmission of the second random access signal, the UE 100 sets transmission power to be higher than in transmission of the first random access signal based on “powerRampingStep.” Specifically, the UE 100 increases the transmission power of the second random access signal by transmission power decided by “powerRampingStep.”

Then, when the random access failure is determined to have occurred, the UE 100 transmits a third random access signal at higher transmission power based on “powerRampingStep.” Specifically, the UE 100 further increases the transmission power of the third random access signal by transmission power decided by “powerRampingStep.”

(Operation According to Second Embodiment)

In the UE 100-1 that originates the emergency call, the establishment of the RRC connection may be delayed by the repetitive transmission of the random access signal. As a result, it is undesirable that a time taken until a voice call starts is increased.

In this regard, in the second embodiment, “RACH-ConfigCommon” in “RadioResourceConfigCommonSIB” includes a parameter indicating emergency call transmission power in addition to “preambleInitialReceivedTargetPower” and “powerRampingStep.” The emergency call transmission power is transmission power to be applied to transmission of the emergency call random access signal.

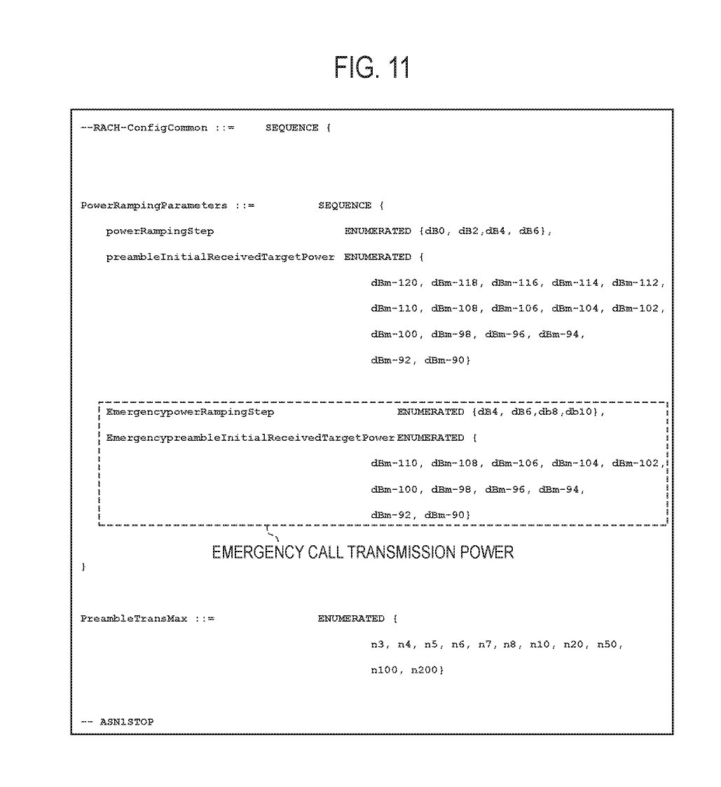

FIG. 11 is a diagram illustrating “RACH-ConfigCommon” according to the second embodiment.

As illustrated in FIG. 11, “RACH-ConfigCommon” includes “EmergencypreambleInitialReceivedTargetPower” and “EmergencypowerRampingStep” as the parameter indicating the emergency call transmission power. “EmergencypreambleInitialReceivedTargetPower” is a parameter indicating initial transmission power of the emergency call random access signal. “EmergencypowerRampingStep” is a parameter indicating an increase in transmission power of the second or later emergency call random access signal.

The emergency call transmission power is set to power higher than transmission power to be applied to transmission of the non-emergency call random access signal. Specifically, “EmergencypreambleInitialReceivedTargetPower” is set to a value larger than normal “preambleInitialReceivedTargetPower.” “EmergencypowerRampingStep” is set to a value larger than normal “powerRampingStep.”

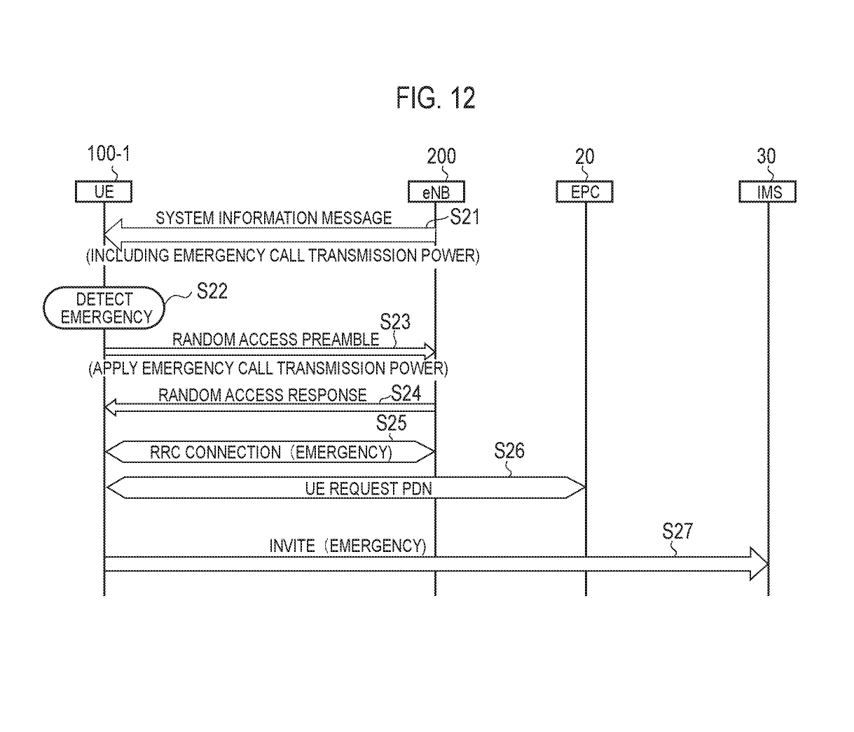

FIG. 12 is an operation sequence diagram according to the second embodiment. The UE 100-1 is a caller terminal that originates the emergency call. In an initial state of the present sequence, the UE 100-1 is in the RRC idle state.

As illustrated in FIG. 12, in step S21, the eNB 200 transmits the broadcast information (SIB) including “RACH-ConfigCommon” The UE 100-1 stores “RACH-ConfigCommon” received from the eNB 200. “RACH-ConfigCommon” may include the information indicating whether or not the eNB 200 supports the emergency call random access signal.

In step S22, the UE 100-1 detects an emergency call origination operation using the user interface 120. The UE 100-1 that has detected the emergency call origination operation starts the random access procedure to the eNB 200 in order to transition to the RRC connection state.

In step S21, the UE 100-1 sets the emergency call transmission power based on “RACH-ConfigCommon” received from the eNB 200. Specifically, the UE 100-1 sets the transmission power of the random access signal based on “EmergencypreambleInitialReceivedTargetPower” and “EmergencypowerRampingStep” included in “RACH-ConfigCommon”.

In step S23, the UE 100-1 applies the emergency call transmission power, and transmits the emergency call random access signal to the eNB 200. The emergency call transmission power is set to power higher than transmission power to be applied to transmission of the non-emergency call random access signal. For this reason, the emergency call random access signal is detected in the eNB 200 at a high probability.

In step S24, the eNB 200 transmits the random access response to the emergency call random access signal to the UE 100-1. The UE 100-1 receives the random access response from the eNB 200.

In step S25, the UE 100-1 and the eNB 200 perform the third and fourth processes for establishing the RRC connection. Here, the UE 100-1 includes the information indicating the emergency call in the RRC connection request message, and transmits the RRC connection request message including the information to the eNB 200. The eNB 200 that has received the RRC connection request message preferentially performs a process for the UE 100-1.

In step S26, the UE 100-1 and the EPC 20 perform, for example, a network registration process of the UE 100-1.

In step S27, the UE 100-1 transmits an INVITE message that is a sort of the SIP message to the PDN 30 (the IMS) in order to establish a session with the receiver terminal. Here, the UE 100-1 includes the information indicating the emergency call in the INVITE message, and transmits the INVITE message including the information to the PDN 30 (the IMS). The PDN 30 (the IMS) that has received the INVITE message preferentially performs a process for the UE 100-1.

(Conclusion of Second Embodiment)

In the second embodiment, the broadcast information (SIB) includes the emergency call transmission power to be applied to transmission of the emergency call random access signal. The emergency call transmission power is set to power higher than transmission power to be applied to transmission of the non-emergency call random access signal.

The UE 100-1 applies the emergency call transmission power included in the broadcast information, and transmits the emergency call random access signal to the eNB 200 when the random access is performed in order to originate the emergency call. The eNB 200 receives the emergency call random access signal to which the emergency call transmission power is applied from the UE 100-1.

Thus, the random access by the emergency call can be successfully performed at a high probability. Thus, since the random access failure in the emergency call can be suppressed, the UE 100-1 can quickly establish the RRC connection in the emergency call and quickly start the voice call. On the other hand, since normal transmission power is applied to the random access in the normal call, an increase in interference with a neighboring cell can be suppressed.

### Other Embodiments

The first and second embodiments are not limited to the cases in which they are carried out separately and independently and may be carried out a combined form. It is possible to more reliably suppress the random access failure in the emergency call using both of the first and second embodiments.

In the first embodiment, the UE 100-1 that originates the emergency call may transmit the emergency call random access signal to the eNB 200 and transmit the non-emergency call random access signal to the eNB 200. For example, the UE 100-1 transmits the emergency call random access signal and the non-emergency call random access signal simultaneously or consecutively. At the time of a disaster or the like, when a number of emergency calls are originated, the emergency call signal sequences are likely to overlap. Thus, it is desirable to transmit the non-emergency call random access signal in addition to transmission of the emergency call random access signal.

In the above-described modifications, as one example of the mobile communication system, the LTE system is described. However, the present invention is not limited to the LTE system, and the present invention may be applied to systems other than the LTE system.

The entire contents of Japanese Patent Application No. 2013-121774 (filed on Jun. 10, 2013) are incorporated herein by reference.

### INDUSTRIAL APPLICABILITY

The present invention is useful for mobile communication fields.

1. A user terminal in a mobile communication system in which a voice call of a packet switching scheme is supported, comprising:
a controller configured to perform a process of transmitting, to a base station, a random access signal based on broadcast information received from the base station, wherein
the broadcast information includes a parameter to be applied to transmission of the random access signal for an emergency call, and
when the emergency call is originated, the controller performs the process of transmitting the random access signal for the emergency call to the base station by applying the parameter included in the broadcast information.

2. The user terminal according to claim 1, wherein
the broadcast information further includes information whether or not the base station supports the random access signal for the emergency call, and
when the emergency call is originated, and the base station supports the random access signal for the emergency call, the controller perform a process of transmitting the random access signal for the emergency call to the base station by applying the parameter included in the broadcast information.

3. The user terminal according to claim 1, wherein
the parameter is a parameter indicating a signal sequence to be applied to the transmission of the random access signal for the emergency call.

4. The user terminal according to claim 3, wherein
the signal sequence is secured separately from a signal sequence to be applied to transmission of the random access signal for a non-emergency call.

5. The user terminal according to claim 1, wherein
the parameter is a parameter indicating transmission power to be applied to the transmission of the random access signal for the emergency call.

6. The user terminal according to claim 5, wherein
the transmission power is set to power higher than transmission power to be applied to transmission of the random access signal for a non-emergency call.

7. A base station in a mobile communication system in which a voice call of a packet switching scheme is supported, comprising:
a transmitter configured to transmit broadcast information including a parameter for an emergency call, to be applied to transmission of an emergency call random access signal; and
a receiver configured to receive the random access signal for the emergency call, to which the parameter is applied, from a user terminal that performs random access to the base station to originate the emergency call.

8. The base station according to claim 7, wherein
the broadcast information further includes information indicating whether or not the base station supports the random access signal for the emergency call.

9. The base station according to claim 7, further comprising
a controller configured to preferentially perform a process for the random access signal for the emergency call when reception of the random access signal for the emergency call conflicts with reception of random access signal for a non-emergency call.

10. The base station according to claim 7, wherein
the parameter is a parameter indicating a signal sequence to be applied to transmission of the random access signal for the emergency call.

11. The base station according to claim 10, wherein
the signal sequence is secured separately from a signal sequence to be applied to transmission of the random access signal for a non-emergency call.

12. The base station according to claim 7, wherein
the parameter is a parameter indicating transmission power to be applied to transmission of the random access signal for the emergency call.

13. The base station according to claim 12, wherein
the transmission power is set to power higher than transmission power to be applied to transmission of the random access signal for a non-emergency call.

14. A processor for controlling a user terminal in a mobile communication system in which a voice call of a packet switching scheme is supported, the processor performing
a process of transmitting, to a base station, a random access signal based on broadcast information received from the base station, wherein
the broadcast information includes a parameter to be applied to transmission of the random access signal for an emergency call, and
when the emergency call is originated, the processor performs the process of transmitting the random access signal for the emergency call to the base station by applying the parameter included in the broadcast information.
